(19) United States
(12) Patent Application Publication
(10) Pub. No.: US 2023/0315173 A1
(43) Pub. Date: Oct. 5, 2023

(54) CONTENT-AWARE NOISE ABATEMENT FOR COOLING DEVICES

(71) Applicant: Lenovo Global Technology (United States) Inc., Morrisville, NC (US)

(72) Inventors: Israel Dias, Apex, NC (US); Gary D. Cudak, Raleigh, NC (US); James G. McLean, Raleigh, NC (US)

(21) Appl. No.: 17/708,705

(22) Filed: Mar. 30, 2022

(51) Int. Cl. G06F 1/20; G06F 3/16

(52) U.S. Cl. CPC G06F 1/206; G06F 1/203; G06F 3/165

(57) ABSTRACT

A method for reducing cooling device noise during quiet times during media playback includes monitoring a sound level of media being presented. The media includes an audio track and the media is presented to a user through an electronic device. Heat from the electronic device is managed by heat management equipment. The method includes determining that a sound level of the media is reduced and adjusting the heat management equipment to reduce noise from the heat management equipment while the sound level of the media is reduced.

### FIELD

The subject matter disclosed herein relates to sound management during playback of media and more particularly relates to reducing cooling device noise during quiet times during media playback.

### BACKGROUND

During playback of media, such as video recordings, sound recordings, video games, and the like there are often times during playback of the media where the sound level of the media is low. Heat management equipment of the playback device, for a space surrounding the playback device or for a room where the user is playing the media, such as a video or sound recording, may have an noise level that affects the user's enjoyment of the media.

### BRIEF SUMMARY

A method for reducing cooling device noise during quiet times during media playback is disclosed. An apparatus and computer program product also perform the functions of the method. The method includes monitoring a sound level of media being presented. The media includes an audio track and the media is presented to a user through an electronic device. Heat from the electronic device is managed by heat management equipment. The method includes determining that a sound level of the media is reduced and adjusting the heat management equipment to reduce noise from the heat management equipment while the sound level of the media is reduced.

An apparatus for reducing cooling device noise during quiet times during media playback includes a processor and non-transitory computer readable storage media storing code. The code is executable by the processor to perform operations that include monitoring a sound level of media being presented. The media includes an audio track. The media is presented to a user through an electronic device and heat from the electronic device is managed by heat management equipment. The operations include determining that a sound level of the media is reduced and adjusting the heat management equipment to reduce noise from the heat management equipment while the sound level of the media is reduced.

A program product for reducing cooling device noise during quiet times during media playback includes a non-transitory computer readable storage medium storing code. The code is configured to be executable by a processor to perform operations that include monitoring a sound level of media being presented. The media includes an audio track and the media is presented to a user through an electronic device where heat from the electronic device is managed by heat management equipment. The operations include determining that a sound level of the media is reduced and adjusting the heat management equipment to reduce noise from the heat management equipment while the sound level of the media is reduced.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for reducing cooling device noise during quiet times during media playback, according to various embodiments;

FIG. 2 is a schematic block diagram illustrating an apparatus for reducing cooling device noise during quiet times during media playback, according to various embodiments;

FIG. 3 is a schematic block diagram illustrating another apparatus for reducing cooling device noise during quiet times during media playback, according to various embodiments;

FIG. 4 is a schematic flow chart diagram illustrating a method for reducing cooling device noise during quiet times during media playback, according to various embodiments;

FIG. 5 is a schematic flow chart diagram illustrating another method for reducing cooling device noise during quiet times during media playback that includes buffering media playback and using the buffer period to adjust heat management equipment to reduce noise, according to various embodiments;

FIG. 6 is a schematic flow chart diagram illustrating another method for reducing cooling device noise during quiet times during media playback by reading metadata or data of the media before playing to adjust heat management equipment during quiet times, according to various embodiments;

FIG. 7 is a schematic flow chart diagram illustrating a method for correlating noise levels of heat management equipment with operating commands of the heat management equipment, according to various embodiments; and

FIG. 8 is a schematic flow chart diagram illustrating a method for maintaining noise levels of heat management equipment below sound levels of media being played, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or “Flash memory”), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for reducing cooling device noise during quiet times during media playback is disclosed. An apparatus and computer program product also perform the functions of the method. The method includes monitoring a sound level of media being presented. The media includes an audio track and the media is presented to a user through an electronic device. Heat from the electronic device is managed by heat management equipment. The method includes determining that a sound level of the media is reduced and adjusting the heat management equipment to reduce noise from the heat management equipment while the sound level of the media is reduced.

In some embodiments, determining that the sound level of the media is reduced includes determining that the sound level of the media is below a sound threshold and adjusting the heat management equipment to reduce noise from the heat management equipment while the sound level of the media is reduced is in response to determining that the sound level of the media is below the sound threshold. In other embodiments, monitoring the sound level of the media being presented includes determining a time when the sound level of the media is reduced as the media is read and buffering the media to create a time delay between reading the media and presenting the media. In the embodiments, adjusting the heat management equipment to reduce noise from the heat management equipment while the sound level of the media is reduced includes adjusting the heat management equipment to reduce noise from the heat management equipment to have a reduced sound level when the media is played after the time delay during the time when the sound level is reduced.

In some embodiments, monitoring the sound level of the media being presented includes reading metadata of the media, where the metadata includes information regarding portions of the media with a reduced sound level, and/or reading the media prior to playing the media to determine portions of the media with a reduced sound level. In the embodiments, adjusting the heat management equipment to reduce noise from the heat management equipment while the sound level of the media is reduced includes coordinating adjustment of the heat management equipment to reduce noise with playing the portions of the media with the reduced sound level. In other embodiments, adjusting the heat management equipment to reduce noise from the heat management equipment while the sound level of the media is reduced includes continuously adjusting the heat management equipment to maintain a noise level of the heat management equipment below the sound level of the media by a threshold amount.

In other embodiments, the method includes directing the heat management equipment to overcool the electronic device in anticipation of periods when the sound level of the media is reduced. In other embodiments, the method includes creating a cooling plan in response to reading the metadata of the media and/or reading the media is prior to playing the media and coordinating adjustment of the heat management equipment to reduce noise with playing the portions of the media with the reduced sound level includes using the cooling plan to coordinate adjustment of the heat management equipment to reduce noise with playing the portions of the media with the reduced sound level.

In some embodiments, the method includes monitoring a noise level of the heat management equipment during various operating conditions, recording noise levels of the heat management equipment and accompanying operating commands of the heat management equipment, and correlating recorded operating commands and associated noise levels. In the embodiments, adjusting the heat management equipment to reduce noise from the heat management equipment while the sound level of the media is reduced includes selecting an operating command for the heat management equipment appropriate for the reduced sound level of the media based on the correlation between the operating commands and the noise levels of the heat management equipment. In other embodiments, monitoring a sound level of media being presented includes determining sound levels of the media as the media is read. In other embodiments, the heat management equipment is located within the electronic device. In other embodiments, at least a portion of the heat management equipment manages heat in a space surrounding the electronic device.

An apparatus for reducing cooling device noise during quiet times during media playback includes a processor and non-transitory computer readable storage media storing code. The code is executable by the processor to perform operations that include monitoring a sound level of media being presented. The media includes at least an audio track and may include video. The media is presented to a user through an electronic device and heat from the electronic device is managed by heat management equipment. The operations include determining that a sound level of the media is reduced and adjusting the heat management equipment to reduce noise from the heat management equipment while the sound level of the media is reduced.

In some embodiments, determining that the sound level of the media is reduced includes determining that the sound level of the media is below a sound threshold and adjusting the heat management equipment to reduce noise from the heat management equipment while the sound level of the media is reduced is in response to determining that the sound level of the media is below the sound threshold. In other embodiments, monitoring the sound level of the media being presented includes determining a time when the sound level of the media is reduced as the media is read and buffering the media to create a time delay between reading the media and presenting the media. In the embodiments, adjusting the heat management equipment to reduce noise from the heat management equipment while the sound level of the media is reduced includes adjusting the heat management equipment to reduce noise from the heat management equipment to have a reduced sound level when the media is played after the time delay during the time when the sound level is reduced.

In some embodiments, monitoring the sound level of the media being presented includes reading metadata of the media, where the metadata includes information regarding portions of the media with a reduced sound level, and/or reading the media prior to playing the media to determine portions of the media with a reduced sound level. In the embodiments, adjusting the heat management equipment to reduce noise from the heat management equipment while the sound level of the media is reduced includes coordinating adjustment of the heat management equipment to reduce noise with playing the portions of the media with the reduced sound level. In other embodiments, adjusting the heat management equipment to reduce noise from the heat management equipment while the sound level of the media is reduced includes continuously adjusting the heat management equipment to maintain a noise level of the heat management equipment below the sound level of the media by a threshold amount. In other embodiments, the operations include directing the heat management equipment to overcool the electronic device in anticipation of periods when the sound level of the media is reduced.

In other embodiments, the method includes monitoring a noise level of the heat management equipment during various operating conditions, recording noise levels of the heat management equipment and accompanying operating commands of the heat management equipment, and correlating recorded operating commands and associated noise levels. In the embodiments, adjusting the heat management equipment to reduce noise from the heat management equipment while the sound level of the media is reduced includes selecting an operating command for the heat management equipment appropriate for the reduced sound level of the media based on the correlation between the operating commands and the noise levels of the heat management equipment.

A program product for reducing cooling device noise during quiet times during media playback includes a non-transitory computer readable storage medium storing code. The code is configured to be executable by a processor to perform operations that include monitoring a sound level of media being presented. The media includes at least an audio track and may include video. The media is presented to a user through an electronic device where heat from the electronic device is managed by heat management equipment. The operations include determining that a sound level of the media is reduced and adjusting the heat management equipment to reduce noise from the heat management equipment while the sound level of the media is reduced.

In some embodiments, determining that the sound level of the media is reduced includes determining that the sound level of the media is below a sound threshold and adjusting the heat management equipment to reduce noise from the heat management equipment while the sound level of the media is reduced is in response to determining that the sound level of the media is below the sound threshold. In other embodiments, monitoring the sound level of the media being presented includes determining a time when the sound level of the media is reduced as the media is read and buffering the media to create a time delay between reading the media and presenting the media, and adjusting the heat management equipment to reduce noise from the heat management equipment while the sound level of the media is reduced includes adjusting the heat management equipment to reduce noise from the heat management equipment to have a reduced sound level when the media is played after the time delay during the time when the sound level is reduced.

In other embodiments, monitoring the sound level of the media being presented includes reading metadata of the media, where the metadata includes information regarding portions of the media with a reduced sound level, and adjusting the heat management equipment to reduce noise from the heat management equipment while the sound level of the media is reduced includes coordinating adjustment of the heat management equipment to reduce noise with playing the portions of the media with the reduced sound level. In other embodiments, monitoring the sound level of the media being presented includes reading the media prior to playing the media to determine portions of the media with a reduced sound level, and adjusting the heat management equipment to reduce noise from the heat management equipment while the sound level of the media is reduced includes coordinating adjustment of the heat management equipment to reduce noise with playing the portions of the media with the reduced sound level.

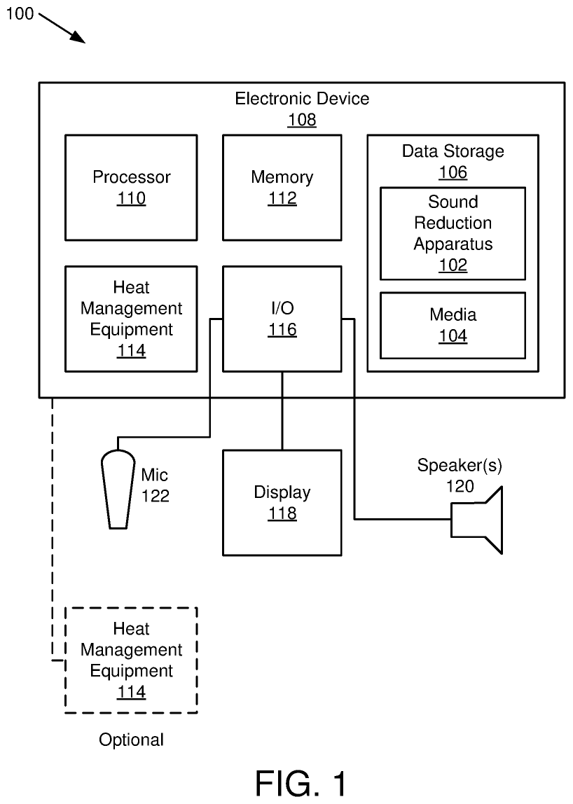

FIG. 1 is a schematic block diagram illustrating a system 100 for reducing cooling device noise during quiet times during media playback, according to various embodiments. The system 100 includes a sound reduction apparatus 102 and media 104 for playback in data storage device 106 of an electronic device 108. The electronic device 108 includes a processor 110, memory 112, heat management equipment 114, and input/output components 116. The system 100 includes a display 118, a speaker 120, a microphone 122, and optionally heat management equipment 114 external to the electronic device 108. Components 102-122 of the system 100 are described below.

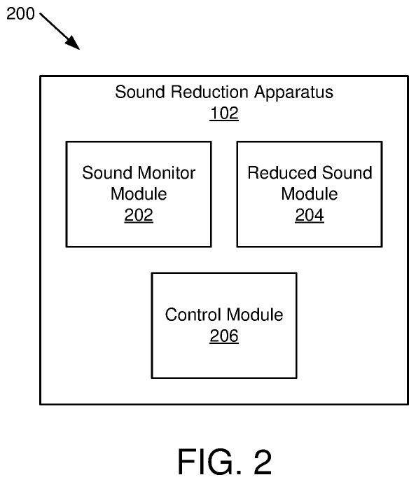

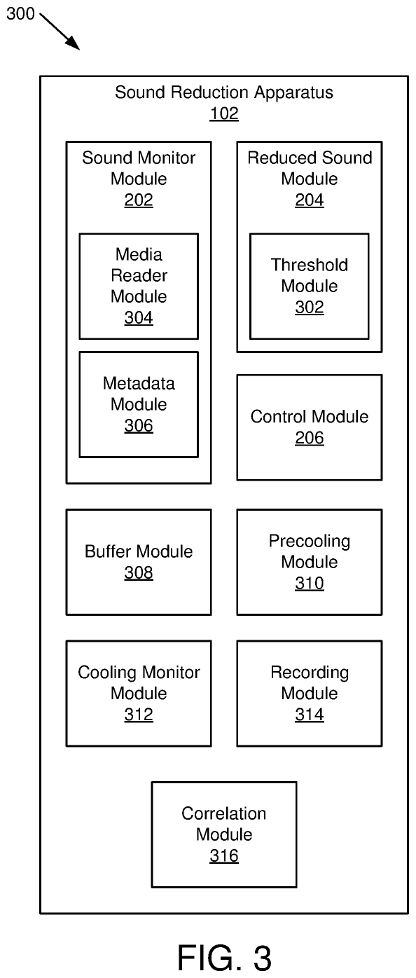

The system 100 includes a sound reduction apparatus 102 configured to reduce noise from heat management equipment when the sound level of media 104 being played. In some embodiments, the sound reduction apparatus 102 senses sound levels as the media 104 is played. In other embodiments, the sound reduction apparatus 102 reads the media 104 as the media 104 is played. In some embodiments, the sound reduction apparatus 102 buffers the media 104 to delay playback giving the sound reduction apparatus 102 time to adjust the heat management equipment 114. In other embodiments, the sound reduction apparatus 102 reads metadata of the media 104 where the metadata includes information about quiet times during media playback and the sound reduction apparatus 102 uses the information from the metadata to create a sound reduction plan for adjusting the heat management equipment 114 during playback. In other embodiments, the sound reduction apparatus 102 reads the media 104 prior to playback to create the sound reduction plan. The sound reduction apparatus 102 is discussed below with regard to the apparatuses 200, 300 of FIGS. 2 and 3.

The media 104, in some embodiments, is played by a user for various purposes, such as entertainment, learning, etc. In some embodiments, the media 104 includes both video and audio. In other embodiments, the media 104 includes audio without video. In some embodiments, the media 104 is interactive involving input from the user, such as a video game, content for a virtual reality headset, or the like. In other embodiments, the media 104 does not include input from the user. In some embodiments, the media 104 is stored in data storage 106 in the electronic device 108. In other embodiments, the media 104 is located external to the electronic device 108 and is accessible to the electronic device 108.

In some examples, the media 104 is streamed from an external source, such as a content provider, a website, etc. In other examples, the media 104 is stored in an external data storage device connected to the electronic device 108, either directly or over a network. The network, in various embodiments, includes a LAN, a WAN, a public network such as the Internet, etc. The network may include a wired connection, a fiber connection, a wireless connection, and the like. Typically, the electronic device 108 includes a network interface card (“NIC”) or the like for connection to the network. One of skill in the art will recognize other media 104 with an audio portion that gets quiet at times during playback and locations for the media 104.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ®). Alternatively, the wireless connection may be a cellular telephone network communication. All standards and/or connection types include the latest version and revision of the standard and/or connection type as of the filing date of this application.

The data storage device 106, in some embodiments, is located in the electronic device 108. In various embodiments, the data storage device 106 a solid state storage drive (“SSD”), a hard disk drive (“HDD”), or the like. The SDD may be flash memory, phase change memory, etc. In some embodiments, the data storage 106 is virtual data storage accessible to the electronic device 108 over a connection, a network, etc.

The electronic device 108, in various embodiments, is a laptop computer, a tablet computer, a desktop computer, a game controller, a set top box, a projector, a virtual reality device, a server, or any other computing device capable of playing the media 104 and transmitting sound from the media 104 over the speaker 120 or speakers 120. The electronic device 108 includes or is cooled (or heated) by heat management equipment 114 that makes noise where adjustment of the heat management equipment 114 reduces noise during quiet periods of media playback.

The electronic device 108 includes a processor 110, such as a central processing unit (“CPU”) configured to execute code, data, etc. The code may be an application, a program, or other machine readable instructions. In some embodiments, the processor 110 executes an application that accesses and plays the media 104. In various embodiments, the processor 110 includes one or more cores. One of skill in the art will recognize various embodiments of a processor 110 for the electronic device 108.

The electronic device 108 includes memory 112 accessible by the processor 110. The processor 110, in various embodiments, uses the memory 112 to store code and/or data from one or more applications, data files, the media 104, the sound reduction apparatus 102, etc. stored in data storage 106 for easy access during execution of code. In some embodiments, the processor 110 stores data from the media 104 for buffering the media 104. One of skill in the art will recognize other uses for the memory 112 in connection with the processor 110.

In some embodiments, the electronic device 108 includes heat management equipment 114 capable of generating noise. In some embodiments, the heat management equipment 114 includes one or more fans in the electronic device 108. In other embodiments, the heat management equipment 114 includes other devices that generate noise, such as a pump for a liquid cooled device. In other embodiments, optionally all or a portion of the heat management equipment 114 is external to the electronic device 108. For example, the electronic device 108 may be located in a cabinet and the cabinet may include a fan. In other embodiments, the electronic device is located in a closet, dedicated electronics room adjacent to a theater room, or similar space and the space includes a fan, a fan coil unit, a damper in an air duct, or other element of a heating, ventilation, and air conditioning (“HVAC”) system.

In various embodiments, the electronic device 108 includes heat management equipment 114 inside and external to the electronic device 108. In some embodiments, the heat management equipment 114 is dedicated to cooling (and/or heating) of the electronic device 108 and/or other devices connected to the electronic device 108. Such heat management equipment 114 may incidentally also provide cooling/heating for a space where the user is enjoying playback of the media 104. One of skill in the art will recognize other forms of heat management equipment 114 that makes noise and provides cooling/heating for the electronic device 108.

The electronic device 108 includes various input/output (“I/O”) components 116 for connection to a display 118, speakers 120, a microphone 122, a keyboard, a mouse, a track ball, a joystick, a game controller, etc. The I/O components 116, in some embodiments, includes a bus, such as a peripheral component interface express (“PCIe”) bus, a universal serial bus (“USB”), or the like and associated connectors. In some embodiments, various I/O devices, such as a keyboard, mouse, game controller, projector, etc. are connected wirelessly to the electronic device 108. One of skill in the art will recognize other devices, buses, components, connectors, etc. to facilitate connection to the electronic device 108 to peripheral equipment.

The system 100 includes, in some embodiments, a display 118 configured to display content from the media 104. In some examples, the display 118 is an electronic display, such as a monitor, a television, etc. In other embodiments, the display 118 is a projector that projects content from the media 104 onto a screen. In other embodiments, the electronic device 108 is a projector and the display 118 is a screen. In some embodiments, the display 118 is built into the electronic device 108. In some examples, the electronic device 108 is a virtual reality (“VR”) headset and the display 118 is part of the VR headset. In other embodiments, the electronic device 108 is a laptop computer, a tablet computer, etc. and the display 118 is an electronic display built into the electronic device 108.

The system 100 includes one or more speakers 120. In some embodiments, the one or more speakers 120 are external to the electronic device 108. In some embodiments, the system 100 includes a receiver that drives the speakers 120 and the electronic device 108 is connected to the receiver. In other embodiments, the speakers 120 are part of a headset, headphones, ear buds, wireless earbuds, a VR headset, or the like. In other embodiments, the speakers 120 are part of the electronic device 108. One of skill in the art will recognize other forms of speakers 120 that play sound from the media 104.

The system 100, in some embodiments, includes a microphone 122 (or microphones 122). In some embodiments, the microphone 122 is built into the electronic device 108. In some embodiments, the microphone 122 is incorporated with the speakers 120, such as in a headset, headphones, a VR headset, etc. In other embodiments, the microphone 122 is external to the electronic device 108. In some embodiments, the sound reduction apparatus 102 uses the microphone 122 to monitor sound levels during playback of the media 104. In other embodiments, the sound reduction apparatus 102 uses the microphone 122 to monitor noise of the heat management equipment 114. One of skill in the art will recognize other ways for the sound reduction apparatus 102 to make use of a microphone 122.

FIG. 2 is a schematic block diagram illustrating an apparatus 200 for reducing cooling device noise during quiet times during media playback, according to various embodiments. The apparatus 200 includes a sound reduction apparatus 102 with a sound monitor module 202, a reduced sound module 204, and a control module 206, which are described below. In some embodiments, all or a portion of the apparatus 200 is implemented with executable code stored on computer readable storage media, such as the data storage device 106, which is executable by the processor 110. In other embodiments, all or a portion of the apparatus 200 is implemented by a programmable hardware device, such as an FPGA, a programmable logic array (“PLA”), or the like. In such examples, the apparatus 200 may include an electronic device 108 that is a VR headset, a game controller, etc. In some embodiments, all or a portion of the apparatus 200 is implemented with hardware circuits.

The apparatus 200 includes a sound monitor module 202 configured to monitor a sound level of media 104 being presented. The media 104 includes an audio track and the media 104 is presented to a user through an electronic device 108. Heat from the electronic device 108 is managed by heat management equipment 114. In some embodiments, the sound monitor module 202 monitors sound levels of the media 104 with the microphone 122. In other embodiments, the sound monitor module 202 monitors sound levels of the media 104 when the media 104 is read.

Monitoring sound levels of the media 104 includes monitoring decibel levels or similar metric of sound produced by the media 104 during playback by the electronic device 108. In some embodiments, the sound monitor module 202 determines a highest sound level and a lowest sound level during playback of the media 104 for a relative determination of a reduced sound level. In other embodiments, the sound monitor module 202 monitors sound levels as an absolute sound pressure in decibels and a reduced sound level is below a particular decibel level.

In some embodiments, the sound monitor module 202 monitors sound levels of the media 104 as the media is played, for example, with the microphone 122. In other embodiments, the sound monitor module 202 monitors sound levels of the media 104 by reading the media 104. In some embodiments, the sound monitor module 202 filters out other noise from people, pets, etc. in the vicinity of the electronic device 108, display 118, speakers 120, etc. In other embodiments, the sound monitor module 202 isolates sound levels from playback of the media 104 from noise from the heat management equipment 114.

The apparatus 200 includes a reduced sound module 204 configured to determine that a sound level of the media 104 is reduced. In some embodiments, the reduced sound module 204 determines that the sound level of the media 104 is below a particular sound threshold or level. In other embodiments, the reduced sound module 204 determines that the sound level of the media 104 is reduced relative to noise of the heat management equipment 114. In some examples, the reduced sound module 204 determines that the sound level of the media 104 is reduced by determining that the sound level of the media 104 is in a range where noise from the heat management equipment 114 will affect enjoyment of a user of playback of the media 104.

The apparatus 200 includes a control module 206 configured to adjust the heat management equipment 114 to reduce noise from the heat management equipment 114 while the sound level of the media 104 is reduced. In some embodiments, the control module 206 turns off one or more fans, turns of a fan coil unit, stops a motor, stops a pump, closes an air damper, or the like. In other embodiments, the control module 206 reduces a speed of one or more fans, of a fan coil unit, of a motor, a pump, of a condenser, or the like.

It would be undesirable for the heat management equipment 114 to switch back-and-forth between normal operations and a reduced sound mode too quickly. In some embodiments, the control module 206 includes a hysteresis loop associated with monitoring for sound levels of the media 104 to prevent adjustments to the heat management equipment 114 that are too frequent. In other embodiments, the control module 206 include a time delay for a reduced noise mode and a normal operation mode to prevent frequent switching between the two modes.

In other embodiments, the control module 206 averages sound level readings over a time window to smooth out quick transitions in sound levels. For example, if the sound level of the media 104 is reduced, such as below a sound threshold, for a second, two seconds, or some other very brief time period, the control module 206 does not adjust the noise level of the heat management equipment 114, but if the sound level of the media 104 is reduced for a longer period of time, such as 5 seconds, 10 seconds, etc., the control module 206 adjusts the heat management equipment 114 to reduce noise.

Likewise, if the sound level of the media 104 is low and increases briefly, such as for a second, two seconds, or other brief time period, the control module 206 maintains the noise level of the heat management equipment 114 low. The heat management equipment 114 may not be capable of quickly switching between modes. For example, the time to stop or start a fan may be on the order of several seconds. One of skill in the art will recognize other ways for the control module 206 to reduce noise of the heat management equipment 114 for periods of reduced sound level of the media 104 while preventing adjustment of the heat management equipment 114 too quickly and one of skill in the art will recognize other appropriate time limits to limit switching between modes.

In some embodiments, the control module 206 interfaces with a control system that controls the heat management equipment. In other embodiments, the control module 206 interfaces with an HVAC system. In various embodiments, the control module 206 sends one or more commands to a control system, to an HVAC system, etc. and the control system, HVAC system, etc. interpret the one or more commands and adjust the heat management equipment 114. The control module 206 adjusts the heat management equipment 114 to reduce noise from the heat management equipment 114.

FIG. 3 is a schematic block diagram illustrating another apparatus 300 for reducing cooling device noise during quiet times during media playback, according to various embodiments. The apparatus 300 includes a sound reduction apparatus 102 with a sound monitor module 202, a reduced sound module 204, and a control module 206, which are substantially similar to those described above in relation to the apparatus 200 of FIG. 2. In various embodiments, the apparatus 300 includes a threshold module 302 in the reduced sound module 204, a media reader module 304 and a metadata module 306 in the sound monitor module 202, a buffer module 308, a precooling module 310, a cooling monitor module 312, a recording module 314 and/or a correlation module 316, which are described below. In other embodiments, all or a portion of the apparatus 300 is implemented by a programmable hardware device, such as an FPGA, a PLA, or the like. In such examples, the apparatus 300 may include an electronic device 108 that is a VR headset, a game controller, etc. In some embodiments, all or a portion of the apparatus 300 is implemented with hardware circuits.

In some embodiments, the apparatus 300 includes a threshold module 302 in the reduced sound module 204 configured to determine that sound level of the media 104 is below a sound threshold. In the embodiments, the control module 206 adjusts the heat management equipment 114 in response to the threshold module 302 determining that the sound level of the media 104 is below the sound threshold. In some embodiments, the sound threshold is a fixed decibel amount. In some examples, the sound threshold is chosen based on an expected noise level of the heat management equipment 114.

In other embodiments, the cooling monitor module 312 determines a noise level of the heat management equipment 114 and the threshold module 302 selects an appropriate sound threshold. In other embodiments, the sound threshold is dynamic and the threshold module 302 adjusts the sound threshold based on ambient noise, noise created by the heat management equipment 114, and/or the like. In some embodiments, the threshold module 302 includes a first threshold for reducing noise from the heat management equipment 114 and a second threshold that is higher than the first threshold to return to normal operation of the heat management equipment 114, thus creating a hysteresis loop. In the embodiments, the control module 206 may stop a fan, a fan coil, etc., may reduce speed of the heat management equipment 114, or otherwise dynamically adjust the heat management equipment 114. One of skill in the art will recognize other ways to set and/or adjust the sound threshold.

The apparatus 300, in some embodiments, includes a media reader module 304 in the sound monitor module 202 configured to read the media 104. In some embodiments, the media reader module 304 reads the media 104 as the media 104 is played. In other embodiments, the apparatus 300 includes a buffer module 308 configured to create a buffer of media content from the media 104. In the embodiments, the media reader module 304 reads the media 104 as the media is downloaded, read from the data storage device 106, streamed, etc. and the buffer module 308 is configured to store data from the media 104 in a buffer to create a time delay between reading the media 104 by the media reader module 304 and presenting the media 104. In some embodiments, the buffer is created in memory 112. In other embodiments, the buffer is created in a different data storage device, such as cache, a dedicated buffer, etc.

In other embodiments, the media reader module 304 reads the media 104 prior to playback of the media 104. In some embodiments, the media reader module 304 reads the media 104 to determine sound levels throughout the media 104 and to determine points in the playback of the media 104 when the sound level of the media 104 is reduced, for example, below the sound threshold. In the embodiments, the control module 206 uses the sound levels determined by the media reader module 304 to adjust the heat management equipment 114.

In other embodiments, the apparatus 300 includes in the sound monitor module 202 a metadata module 306 reads metadata of the media 104 where the metadata include information regarding sound levels during playback of the media and/or times during playback when the sound level of the media 104 is reduced. In some embodiments, the media reader module 304 reads the media 104 before playback to determine sound levels of the media 104 and the metadata module 306 uses the sound levels read by the media reader module 304 to create the metadata with sound level information. In the embodiments, the control module 206 uses the sound levels from the metadata of the media 104 to adjust the heat management equipment 114.

In some embodiments, the metadata module 306 reads the metadata and the sound monitor module 202, reduced sound module 204, or other portion of the sound reduction apparatus 102 to create a cooling plan based on the metadata or based on the media reader module 304 reading the media 104 before playback. The control module 206 uses the cooling plan during playback to reduce noise during reduced sound levels of the media 104 during playback.

In some embodiments, apparatus 300 includes a precooling module 310 configured to direct the heat management equipment 114 to overcool the electronic device 108 in anticipation of periods when the sound level of the media 104 is reduced. In some embodiments, the precooling module 310 uses the cooling plan for playback of the media 104 to maintain cooling of the electronic device 108 to within acceptable limits during playback of the media 104 while reducing noise of the heat management equipment 114 during reduced sound levels of media playback. The cooling plan, in some embodiments, includes amounts of overcooling to compensate for reduced cooling during times of reduced sound levels of media playback.

In some embodiments, the apparatus 300 continuously adjusts the heat management equipment 114 to maintain noise levels of the heat management equipment 114 a threshold amount below the sound level of the media 104 being played. In some embodiments, the control module 206 uses a cooling plan created from the metadata or by reading the media 104 before the media 104 is played to determine when to adjust the heat management equipment 114 to reduce noise and when to adjust the heat management equipment 114 to overcool the electronic device 108 in anticipation of time of reduction of noise from the heat management equipment 114. The threshold amount, in some embodiments, is an amount designed to keep noise levels of the heat management equipment 114 from being a distraction while a user is playing the media 104.

In some embodiments, the threshold amount is dynamic or changes a specific amount in order to prevent overheating of the electronic device 108. For example, where the average sound level of the media 104 is high, the control module 206 may be able to maintain adequate levels of cooling of the electronic device 108 with a default threshold amount. Different media 104 may have an average sound level that is reduced so that the control module 206 is unable to maintain adequate cooling for the duration of media playback without reducing the threshold amount.

In some embodiments, the apparatus 300 includes a cooling monitor module 312 configured to monitor a noise level of the heat management equipment 114 during various operating conditions, a recording module 314 configured to record noise levels of the heat management equipment 114 and accompanying operating commands of the heat management equipment 114, and a correlation module 316 configured to correlate recorded operating commands and sound levels. In the embodiments, the control module 206 selects an operating command for the heat management equipment 114 appropriate for the reduced sound level based on the correlation between the operating commands and the noise levels of the heat management equipment 114.

In some examples, the cooling monitor module 312 records a high noise level of the heat management equipment 114 during times when fans are turned on, the fans are operating at full speed, motors are operating, etc. and the recording module 314 records the noise level from the heat management equipment 114 and the associated operating commands. The correlation module 316 correlates the noise level from the heat management equipment 114 with the associated operating commands. The cooling monitor module 312, recording module 314, and correlation module 316 repeats the operations for other operating conditions, including times when the fans, fan coil, motors, etc. are off. In some embodiments, the cooling monitor module 312, recording module 314, and correlation module 316 operate during times when the media 104 is not playing, when ambient noise is low, etc. to avoid media contribution to recording of noise levels of the heat management equipment 114. In other embodiments, the cooling monitor module 312 filters out sound from playback of the media 104, ambient noise, voices of users, and the like.

In some embodiments, the cooling monitor module 312, recording module 314, and correlation module 316 operate separately for each electronic device 108. In other embodiments, the cooling monitor module 312, recording module 314, and correlation module 316 are used on various electronic devices 108 in various locations and report noise levels, operating conditions, equipment information, etc. to a central location and machine learning is used to correlate noise levels with operating commands. The correlations are then transmitted to various sound reduction apparatuses 102 for use in reducing noise during quiet time of media playback. In other embodiments, the machine learning is updated over time with additional data from the sound reduction apparatuses 102.

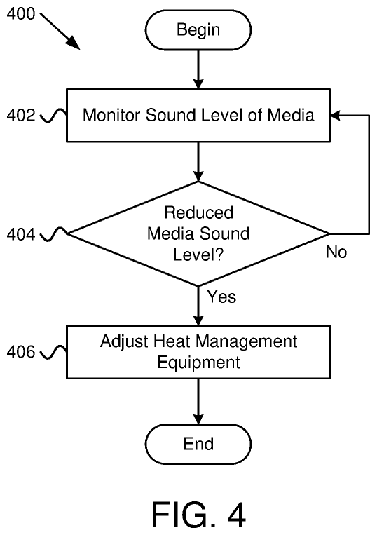

FIG. 4 is a schematic flow chart diagram illustrating a method 400 for reducing cooling device noise during quiet times during media playback, according to various embodiments. The method 400 begins and monitors 402 a sound level of media 104 being presented. The media 104 includes at least an audio track, but may include video as well. The media 104 is being presented to a user through an electronic device 108 and heat from the electronic device 108 is managed by heat management equipment 114. The method 400 determines 404 if a sound level of the media 104 is reduced. If the method 400 determines 404 that the sound level of the media 104 is not reduced, the method 400 continues to monitor 402 the sound level of the media 104.

If the method 400 determines 404 that the sound level of the media 104 is reduced, the method 400 adjusts 406 the heat management equipment 114 to reduce noise from the heat management equipment 114 while the sound level of the media 104 is reduced, and the method 400 ends. In various embodiments, all or a portion of the method 400 is implemented using the sound monitor module 202, the reduced sound module 204, and/or the control module 206.

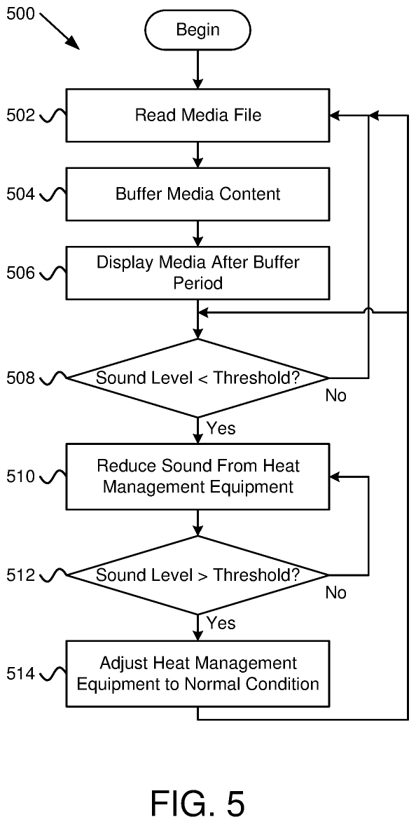

FIG. 5 is a schematic flow chart diagram illustrating another method 500 for reducing cooling device noise during quiet times during media playback that includes buffering media playback and using the buffer period to adjust heat management equipment 114 to reduce noise, according to various embodiments. The method 500 begins and reads 502 a media file of the media 104 and buffers 504 content of the media 104 for a specified period of time and displays 506 the media 104 after the buffer period. The method 500 determines 508, at the time the media 104 is read 502, if a sound level of the media 104 is below a sound threshold. If the method 500 determines 508 that the sound level of the media 104 is not below the sound threshold, the method 500 continues to read 502 the sound level of the media 104.

If the method 500 determines 508 that the sound level of the media 104 is below the sound threshold, the method 500 adjusts 510 the heat management equipment 114 to reduce noise from the heat management equipment 114 to have a reduced sound level when the media 104 is played after the time delay during the time when the sound level is reduced. While the heat management equipment 114 is adjusted to reduce noise, the method 500 continues to monitor sound levels of the media 104 and determines 512 if the sound level of the media 104 goes above the sound level threshold.

If the method 500 determines 512 that the sound level of the media 104 is still below the sound threshold, the method 500 continues to adjust 510 the heat management equipment 114 to reduce noise from the heat management equipment 114 to have a reduced sound level. If the method 500 determines 512 that the sound level of the media 104 is above the sound threshold, the method 500 adjusts 514 the heat management equipment 114 to a normal operating condition, and continues determine 508 if the sound level of the media 104 is below the sound threshold while the media 104 is being read. In various embodiments, all or a portion of the method 500 is implemented using the sound monitor module 202, the reduced sound module 204, the control module 206, the threshold module 302, the media reader module 304, and/or the buffer module 308.

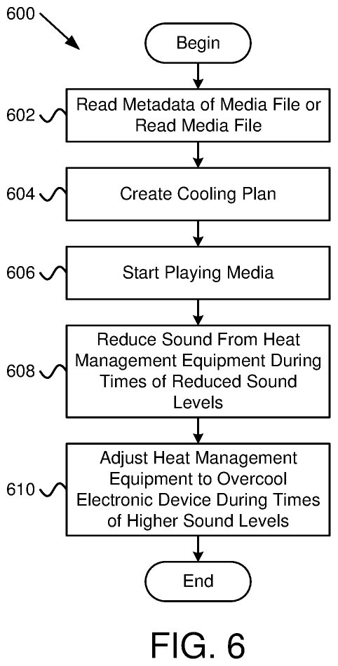

FIG. 6 is a schematic flow chart diagram illustrating another method 600 for reducing cooling device noise during quiet times during media playback by reading metadata or data of the media 104 before playing to adjust heat management equipment 114 during quiet times, according to various embodiments. The method 600 begins and reads 602 metadata of the media 104 or reads 602 the media 104 directly prior to playback of the media 104 and creates 604 a cooling plan. The cooling plan includes an indication of times when the sound level of the media 104 is reduced and other times when the sound level of the media 104 is not reduced. In some examples, the cooling plan uses one or more sound thresholds as triggers to reduce noise from the heat management equipment 114. In other embodiments, the cooling plan looks at trends of the sound levels while ignoring spikes of sound levels of the media 104 to prevent too frequent adjustment of the heat management equipment 114.

The method 600 starts 606 playing the media 104, adjusts 608 operation of the heat management equipment 114 according to the cooling plan to reduce noise of the heat management equipment 114 during times of reduced sound levels of the media 104, and adjusts 610 operation of the heat management equipment 114, according to the cooling plan, to overcool the electronic device 108 during higher sound levels, and the method 600 ends. Overcooling the electronic device 108 is designed to compensate for the times of reduced noise of the adjusted 608 operation of the heat management equipment 114 where fans and other components of heat management equipment 114 to are shut down. In various embodiments, all or a portion of the method 600 is implemented using the sound monitor module 202, the reduced sound module 204, the control module 206, the threshold module 302, the media reader module 304, the metadata module 306, and/or the precooling module 310.

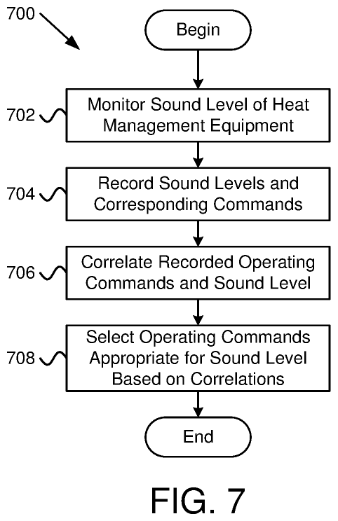

FIG. 7 is a schematic flow chart diagram illustrating a method 700 for correlating noise levels of heat management equipment 114 with operating commands of the heat management equipment 114, according to various embodiments. The method 700 begins and monitors 702 a noise level of the heat management equipment during various operating conditions, records 704 noise levels of the heat management equipment and accompanying operating commands of the heat management equipment 114, and correlates 706 recorded operating commands and associated noise levels. The method 700 selects 708 an operating command for the heat management equipment 114 appropriate for sound levels of the media 104 based on the correlation between the operating commands and the noise levels of the heat management equipment 114, and the method 700 ends.

In some embodiments, the method 700 is for heat management equipment 114 installed at a particular location so that the correlation between noise levels of the heat management equipment 114 and operating commands is tuned to the specific equipment and location. In other embodiments, the method 700 is used to gather information from various heat management equipment 114, locations, etc. and the method 700 uses machine learning to correlate operating commands with noise levels of the management equipment. In the embodiments, the correlations are used for various embodiments described herein. In various embodiments, all or a portion of the method 700 is implemented using the sound monitor module 202, the reduced sound module 204, the control module 206, the threshold module 302, the media reader module 304, metadata module 306, the buffer module 308, the precooling module 310, the cooling monitor module 312, the recording module 314, and/or the correlation module 316.

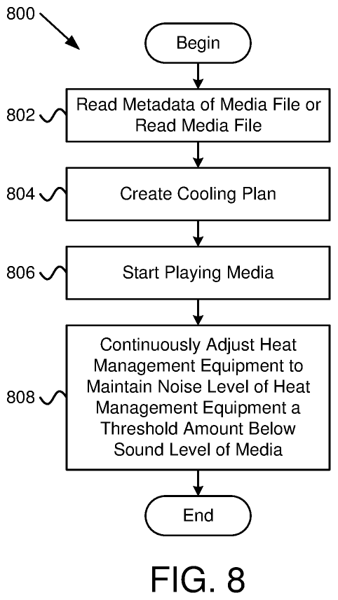

FIG. 8 is a schematic flow chart diagram illustrating a method 800 for maintaining noise levels of heat management equipment 114 below sound levels of media 104 being played, according to various embodiments. The method 800 begins and reads 802 metadata of the media 104 or reads 802 the media 104 directly prior to playback of the media 104 and creates 804 a cooling plan. The cooling plan includes an indication of times when the sound level of the media 104 is reduced and other times when the sound level of the media 104 is not reduced. In some examples, the cooling plan uses one or more sound thresholds as triggers to reduce noise from the heat management equipment 114. In other embodiments, the cooling plan looks at trends of the sound levels while ignoring spikes of sound levels of the media 104 to prevent too frequent adjustment of the heat management equipment 114.

The method 600 starts 606 playing the media 104 and continuously adjusts 808 the heat management equipment 114 to maintain noise levels of the heat management equipment 114 a threshold amount below the sound level of the media 104 as the media 104 is played. The threshold amount, in some embodiments, is an amount designed to keep noise levels of the heat management equipment 114 from being a distraction while a user is playing the media 104. In various embodiments, all or a portion of the method 800 is implemented using the sound monitor module 202, the reduced sound module 204, the control module 206, the threshold module 302, the media reader module 304, metadata module 306, the buffer module 308, the precooling module 310, the cooling monitor module 312, the recording module 314, and/or the correlation module 316.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
monitoring a sound level of media being presented, the media comprising an audio track, the media being presented to a user through an electronic device, wherein heat from the electronic device is managed by heat management equipment;
determining that a sound level of the media is reduced; and
adjusting the heat management equipment to reduce noise from the heat management equipment while the sound level of the media is reduced.

2. The method of claim 1, wherein determining that the sound level of the media is reduced comprises determining that the sound level of the media is below a sound threshold and wherein adjusting the heat management equipment to reduce noise from the heat management equipment while the sound level of the media is reduced is in response to determining that the sound level of the media is below the sound threshold.

3. The method of claim 1, wherein:
monitoring the sound level of the media being presented comprises determining a time when the sound level of the media is reduced as the media is read and buffering the media to create a time delay between reading the media and presenting the media; and
adjusting the heat management equipment to reduce noise from the heat management equipment while the sound level of the media is reduced comprises adjusting the heat management equipment to reduce noise from the heat management equipment to have a reduced sound level when the media is played after the time delay during the time when the sound level is reduced.

4. The method of claim 1, wherein:
monitoring the sound level of the media being presented comprises one of:
reading metadata of the media, wherein the metadata comprises information regarding portions of the media with a reduced sound level; and/or
reading the media prior to playing the media to determine portions of the media with a reduced sound level; and
adjusting the heat management equipment to reduce noise from the heat management equipment while the sound level of the media is reduced comprises coordinating adjustment of the heat management equipment to reduce noise with playing the portions of the media with the reduced sound level.

5. The method of claim 4, wherein adjusting the heat management equipment to reduce noise from the heat management equipment while the sound level of the media is reduced comprises continuously adjusting the heat management equipment to maintain a noise level of the heat management equipment below the sound level of the media by a threshold amount.

6. The method of claim 4, further comprising directing the heat management equipment to overcool the electronic device in anticipation of periods when the sound level of the media is reduced.

7. The method of claim 4, further comprising creating a cooling plan in response to reading the metadata of the media and/or reading the media is prior to playing the media, wherein coordinating adjustment of the heat management equipment to reduce noise with playing the portions of the media with the reduced sound level comprises using the cooling plan to coordinate adjustment of the heat management equipment to reduce noise with playing the portions of the media with the reduced sound level.

8. The method of claim 1, further comprising:
monitoring a noise level of the heat management equipment during various operating conditions;
recording noise levels of the heat management equipment and accompanying operating commands of the heat management equipment; and
correlating recorded operating commands and associated noise levels,
wherein adjusting the heat management equipment to reduce noise from the heat management equipment while the sound level of the media is reduced comprises selecting an operating command for the heat management equipment appropriate for the reduced sound level of the media based on the correlation between the operating commands and the noise levels of the heat management equipment.

9. The method of claim 1, wherein the heat management equipment is located within the electronic device.

10. The method of claim 1, wherein at least a portion of the heat management equipment manages heat in a space surrounding the electronic device.

11. An apparatus comprising:
a processor; and
non-transitory computer readable storage media storing code, the code being executable by the processor to perform operations comprising:
monitoring a sound level of media being presented, the media comprising an audio track, the media being presented to a user through an electronic device, wherein heat from the electronic device is managed by heat management equipment;
determining that a sound level of the media is reduced; and
adjusting the heat management equipment to reduce noise from the heat management equipment while the sound level of the media is reduced.

12. The apparatus of claim 11, wherein determining that the sound level of the media is reduced comprises determining that the sound level of the media is below a sound threshold and wherein adjusting the heat management equipment to reduce noise from the heat management equipment while the sound level of the media is reduced is in response to determining that the sound level of the media is below the sound threshold.

13. The apparatus of claim 11, wherein:
monitoring the sound level of the media being presented comprises determining a time when the sound level of the media is reduced as the media is read and buffering the media to create a time delay between reading the media and presenting the media; and
adjusting the heat management equipment to reduce noise from the heat management equipment while the sound level of the media is reduced comprises adjusting the heat management equipment to reduce noise from the heat management equipment to have a reduced sound level when the media is played after the time delay during the time when the sound level is reduced.

14. The apparatus of claim 11, wherein:
monitoring the sound level of the media being presented comprises one of:
reading metadata of the media, wherein the metadata comprises information regarding portions of the media with a reduced sound level; and/or
reading the media prior to playing the media to determine portions of the media with a reduced sound level; and
adjusting the heat management equipment to reduce noise from the heat management equipment while the sound level of the media is reduced comprises coordinating adjustment of the heat management equipment to reduce noise with playing the portions of the media with the reduced sound level.

15. The apparatus of claim 14, wherein adjusting the heat management equipment to reduce noise from the heat management equipment while the sound level of the media is reduced comprises continuously adjusting the heat management equipment to maintain a noise level of the heat management equipment below the sound level of the media by a threshold amount.

16. The apparatus of claim 14, the operations comprising directing the heat management equipment to overcool the electronic device in anticipation of periods when the sound level of the media is reduced.

17. The apparatus of claim 11, the operations comprising:
monitoring a noise level of the heat management equipment during various operating conditions;
recording noise levels of the heat management equipment and accompanying operating commands of the heat management equipment; and
correlating recorded operating commands and associated noise levels,
wherein adjusting the heat management equipment to reduce noise from the heat management equipment while the sound level of the media is reduced comprises selecting an operating command for the heat management equipment appropriate for the reduced sound level of the media based on the correlation between the operating commands and the noise levels of the heat management equipment.

18. A program product comprising a non-transitory computer readable storage medium storing code, the code being configured to be executable by a processor to perform operations comprising:
monitoring a sound level of media being presented, the media comprising an audio track, the media being presented to a user through an electronic device, wherein heat from the electronic device is managed by heat management equipment;
determining that a sound level of the media is reduced; and
adjusting the heat management equipment to reduce noise from the heat management equipment while the sound level of the media is reduced.

19. The program product of claim 18, wherein determining that the sound level of the media is reduced comprises determining that the sound level of the media is below a sound threshold and wherein adjusting the heat management equipment to reduce noise from the heat management equipment while the sound level of the media is reduced is in response to determining that the sound level of the media is below the sound threshold.

20. The program product of claim 18, wherein:
monitoring the sound level of the media being presented comprises determining a time when the sound level of the media is reduced as the media is read and buffering the media to create a time delay between reading the media and presenting the media and adjusting the heat management equipment to reduce noise from the heat management equipment while the sound level of the media is reduced comprises adjusting the heat management equipment to reduce noise from the heat management equipment to have a reduced sound level when the media is played after the time delay during the time when the sound level is reduced;
monitoring the sound level of the media being presented comprises reading metadata of the media, wherein the metadata comprises information regarding portions of the media with a reduced sound level and adjusting the heat management equipment to reduce noise from the heat management equipment while the sound level of the media is reduced comprises coordinating adjustment of the heat management equipment to reduce noise with playing the portions of the media with the reduced sound level; and/or
monitoring the sound level of the media being presented comprises reading the media prior to playing the media to determine portions of the media with a reduced sound level and adjusting the heat management equipment to reduce noise from the heat management equipment while the sound level of the media is reduced comprises coordinating adjustment of the heat management equipment to reduce noise with playing the portions of the media with the reduced sound level.
